(19) United States
(12) Patent Application Publication
(10) Pub. No.: US 2007/0192332 A1
(43) Pub. Date: Aug. 16, 2007

(54) DISTRIBUTED AUTOMATION SYSTEM

(75) Inventors: Andreas DEUTER, Lemgo (DE); Friedrich WEGENER, Vahlbruch (DE)

Correspondence Address: ROBERTS, MLOTKOWSKI & HOBBES, P. O. BOX 10064, MCLEAN, VA, 22102-8064, US

(73) Assignee: PHOENIX CONTACT GMBH & CO. KG, Blomberg (DE)

(21) Appl. No.: 11/668,585

(22) Filed: Jan. 30, 2007

(30) Foreign Application Priority Data
Jan. 31, 2006 (DE) 10 2206 004 633.1

(51) Int. Cl. G06F 17/30

(52) U.S. Cl. 707/10

(57) ABSTRACT

A distributed automation system is described with at least one first order network device (1, 1′, 1″) and at least one piece of data available on the first order network device, at least one database system (2) and at least one first order network (3). With the distributed automation system, the data acquisition and diagnosis possibilities are improved by the first order network device (1, 1′, 1″) and the database system (2) being directly interconnected via the first order network (3), and by the data from the first order network device (1, 1′, 1″) being able to be transmitted actively and directly via the first order network (3) to the database system (2).

### BACKGROUND OF THE INVENTION

1. Field of the Invention

The invention relates to a distributed automation system with at least one first order network device and at least one piece of data available on the first order network device, at least one database system and at least one first order network. Furthermore, the invention relates to a process for data acquisition in a distributed automation system with at least one network device, at least one piece of data available on the network device, at least one database system for administration of the data originating from the network device, and at least one network.

2. Description of Related Art

Distributed automation systems can be found in all branches of science and technology in which processes are at least partially automated by measurement and control engineering. A distributed automation system is present when different state variables of the process must be detected using measurement engineering or different state variables of the process are to be actively influenced. Regardless of the three-dimensional extent of such a system, it is necessary in a distributed automation system to evaluate the signals of several sensors which are independent of one another on a decentralized basis, to combine and evaluate them centrally to determine the process state, for example, in turn, to derive manipulated variables therefrom which, for their part, are passed on to distributed actuators which ultimately act on the process.

Conventionally, distributed automation systems are functionally divided into various levels. At the lowest level, the input/output level (I/O level), the network devices are, on the one hand, in direct contact with the process, and on the other, they relay measurement data to the next higher level, the control level, or receive control signals from the control level.

In addition to pure measurement data, often, status and diagnosis data are also relayed from the network devices to the control level and are received there, for example, by a control unit. To display measurement data and to evaluate diagnosis data, in the control level, conventionally, there is a local evaluation and switching computer which cyclically polls the corresponding data from one or more control units and displays the desired process quantities or determines the state of the process and network devices using status and diagnosis data (Phoenix Contact, Product catalog “AUTOMATIONWORX 2005”, pages 14 and 15).

The acquisition of data from the I/O level by polling is often technologically compelled, and for example, follows from client-server architecture of conventional equipment interfaces, for which reference is made, by way of example, to the expanded OPC interface (www.opcfoundation.com). After acquiring the data by the local evaluation and switching computer, it is possible to feed data from this computer into the database system; the computer therefore switches between the data sources and sinks of the distributed automation system and the database system.

In practice, the organized filing of diagnosis data in the database system acquires considerable importance, since retrospective and interval evaluation of data is of great interest, whether for long-term observation of the distributed automation system, for fault analysis or for use of data in higher-level business planning tools (“Manufacturing Execution System”, “Enterprise Resource Planning” and “Customer Relationship Management”).

In the different levels of a distributed automation system, generally, quite different technologies are used to implement the necessary networking. In the region of the I/O level, field bus systems play a support role (for example, Interbus, CAN, Profibus), conversely in the higher-ranking levels—therefore, in the region of the control and management level—network technologies are used as are known from the standardized LAN region (local area network), such as, for example, Ethernet (see, e.g., Phoenix Contact, Product catalog “AUTOMATIONWORX 2005”, pages 14 and 15).

### SUMMARY OF THE INVENTION

A primary object of the present invention is to provide a distributed automation system with improved data acquisition and diagnosis possibilities.

The distributed automation system in accordance with the invention in which this object is achieved is characterized in that the first order network device and the database system are directly connected to one another via the first order network, and the piece of data from the first order network device can be transmitted directly via the first order network device to the database system. Within the framework of this invention, a first order network device is defined as any device in an automation system which is directly connected via the network or any data channel to the database system of the automation system; the network which establishes this connection is by definition a first order network.

The distributed automation system in accordance with the invention is advantageous in many respects. Because the first order network devices can send data directly via the first order network to the database system, it is possible to dispense with the local evaluation and switching computer which had been necessary for this purpose and which is interposed between the first order network device and the database system in the distributed automation systems known from the prior art. Even without the local evaluation and switching computer, data acquisition without difficulty is possible. This is especially advantageous for those automation systems in which online data evaluation is not necessary, or a retrospective evaluation of past data at longer time intervals for reliable assessment of the state of the automation system is adequate.

Active transmission of a piece of data from the first order network device to the database system means that the first order network device does not require an external prompt for transmission of data, but rather transmits current, not yet disclosed data—if they are present—automatically to the database system. This measure greatly reduces the burden on the first order network since the periodic interrogation of data carried out independently of the actual presence of new data by the local evaluation and switching computer in the first order network devices is omitted.

Active and direct transmission of data of first order network devices over the first order network to the database system implies that, on the one hand, the first order network devices can be equipped with the corresponding interfaces and that, on the other hand, the database system consisting of the actual data storage—the database—and the administration software—the database management system—must have a corresponding communications interface in terms of hardware, and the database management system and the first order network device exchange data according to a matching protocol.

The distributed automation system in accordance with the invention can be further improved with respect to its utility, if the first order network is made such that serial data transmission can be implemented with it. In a preferred embodiment of the invention, the first order network is made in conformity with a popular standard for local area networks (LANs), currently therefore preferably in agreement with an Ethernet standard. In another configuration of the distributed automation system in accordance with the invention, communication between the first order network device and the database system via the first order network is based on a conventional network protocol, therefore for example, on the TCP/IP protocol (transmission control protocol/Internet protocol). By using a network configured in this way for data transmission between the first order network devices and the database system, the distributed automation system in accordance with the invention can be integrated especial easily into higher-ranking communications networks since they are conventionally based on compatible technologies (Ethernet).

In another configuration of the distributed automation system in accordance with the invention, at least one first order network device is connected via at least one lower order network to at least one lower order network device. This means that a first order network device is not only in a direct connection to the database system, but additionally, can also be connected to other network devices, specifically lower order network devices. Following this principle, of course, also network devices of lower—therefore, for example, the second—order can also be connected to other subordinate network devices of even lower—therefore, for example, the third—order etc.

One typical application of a network device structure which is branched and subordinated in this way is present, for example, in field busses based on the master-slave principle in which one or more slave network devices are connected via the field bus to a master network device which is connected either in accordance with the invention directly via the first network to the database system or is connected via a lower order network to a first order network device.

According to a preferred embodiment of the invention, the database system is connected to a computer via the first order network and/or a separate data channel, and the data stored in the database system can be transmitted from the database system to the computer or can be retrieved by the computer from the database system. The computer can be used especially for data evaluation, data visualization and for diagnosis of the automation system.

To the degree to which the separate data channel is used for data transmission between the database system and the computer, the first order network is relieved of this transmission load. Even when the computer in the database system interrogates new data by periodic polling, in this way data, transfer from the first order network devices to the database system is not adversely affected.

According to another independent teaching of the invention, the object of the invention is achieved by a process for data acquisition in a distributed automation system in which the network device and database of the automation system are directly interconnected via the network and the network device transmits the data actively via the network to the database system.

In particular, there are numerous possibilities for developing and embodying the distributed automation system in accordance with the invention and the process for data acquisition in accordance with the invention. In this regard reference is made to the following description of several embodiments in conjunction with the accompanying drawings.

### BRIEF DESCRIPTION OF THE DRAWINGS

FIG. 1 is a block diagram of a distributed automation system known from the prior art,

FIG. 2 is a block diagram of a preferred embodiment of the distributed automation system in accordance with the invention, and

FIG. 3 shows another embodiment of the distributed automation system in accordance with the invention.

### DETAILED DESCRIPTION OF THE INVENTION

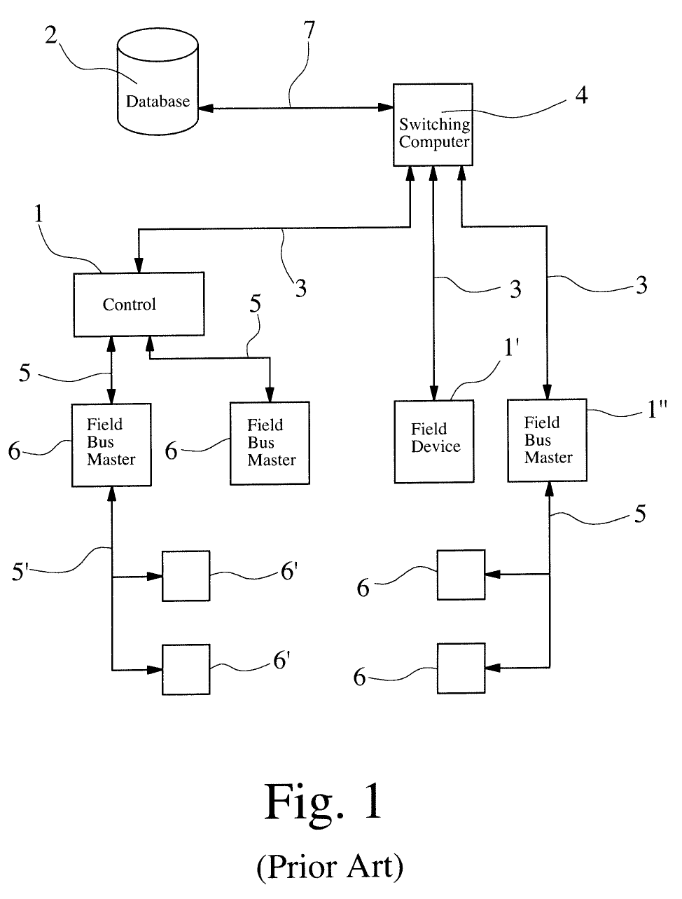

FIG. 1 schematically shows a distributed automation system known from the prior art with first order network devices 1, 1′, 1″, a database system 2 and a first order network 3 which establishes a connection between the first order network devices 1, 1′, 1″ and a local evaluation and switching computer 4.

The first order network devices 1, 1″, 1″ can be devices of quite different types. In the embodiment shown in FIG. 1, the first order network device 1 is a control, the first order network device 1′ is a field device which is directly connected to the process to be automated via its input/output interfaces (which are not shown individually), and first order network device 1″ is a field bus master which is connected via a lower order network 5 to lower order network devices 6, in this case to field devices.

In the same way, the first order network device 1 is connected via a lower order network 5 to lower order network devices 6. The lower order network devices 6 connected to the control 1 are a field bus master which is connected via a still lower order network 5′ to network devices 6′ which are further subordinated.

In the distributed automation system shown in FIG. 1, the lower order terminals 6, 6′ are directly connected to the automated process and they typically relay both measurement data and also the status and diagnosis data relating to them to the higher order network devices until these data have reached the first order network devices 1, 1′, 1″.

In the distributed automation system known from the prior art, the data held in the first order network devices 1, 1′, 1″ are retrieved from the local evaluation and switching computer 4, evaluated and transmitted via another separate data channel 7 to the database system 2. The data originating ultimately from the first order network devices 1, 1′, 1″ must consequently always be collected and processed only by the local evaluation and switching computer 4 before they can be filed in the database system 2.

In FIG. 1, the first order network 3 is shown by three separate connections between the first order network devices 1, 1′, 1″ and the local evaluation and switching computer. In fact, there need not be three separate connections. Instead, from the prior art, it is also known that the first order network can be a single coherent data connection which connects all participants to one another; basically the first order network 3 can therefore have any network architecture.

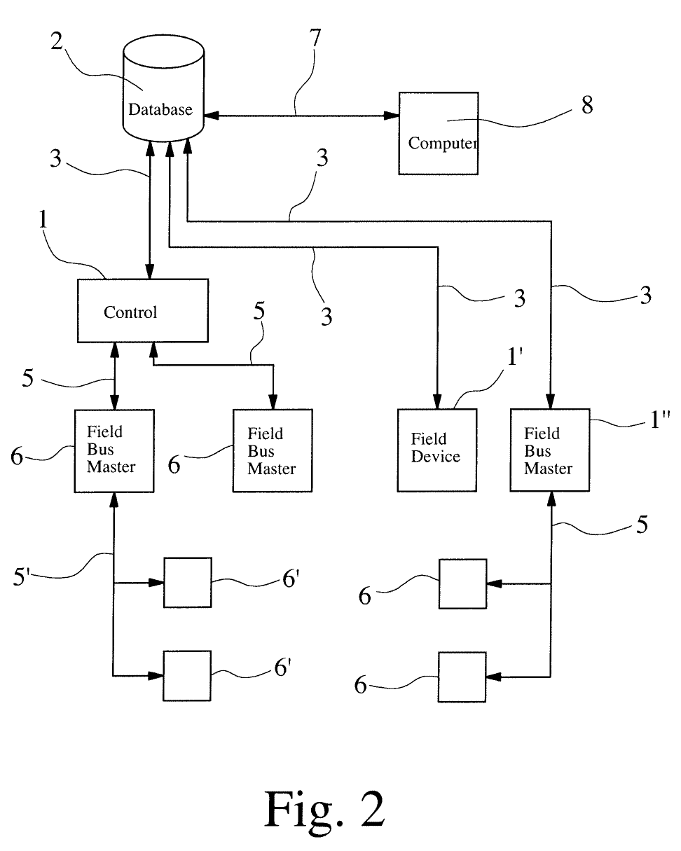

The embodiments of distributed automation system in accordance with the invention shown in FIGS. 2 & 3 differs from the known distributed automation system shown in FIG. 1 essentially in that the first order network devices 1, 1′, 1″ and the database system 2 are directly interconnected via the first order network 3 and that the data from the first order network devices 1, 1′, 1″ can be transmitted actively and directly via the first order network 3 to the database system 2. Thus, the administration of the data originating from the automation system in the database system 2 is independent of the presence of a local evaluation and switching computer 4, as is shown in FIG. 1. Since the data originating from the first order network devices 1, 1′, 1″ moreover are actively transmitted to the database system 2 via the first order network 3, therefore without continuous interrogation of the database system 3 being necessary, the amount of data on the first order network 3 is greatly reduced relative to the approaches known from the prior art.

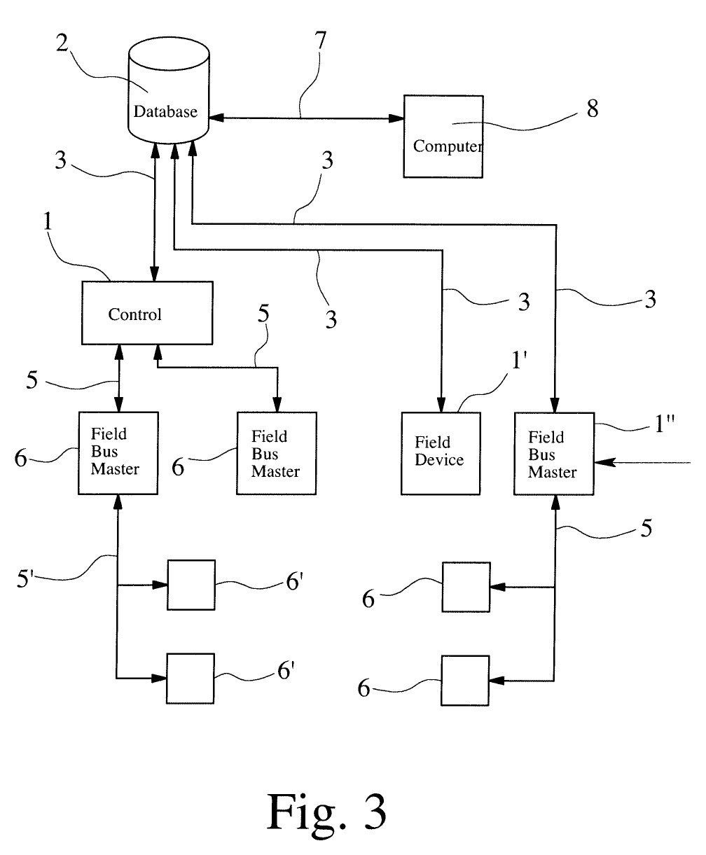

In the embodiments as shown in FIGS. 2 & 3, serial data transmission is accomplished with the first order network 3. The first order network 3 shown in FIG. 3 is an Ethernet network which is operated with a protocol which is based on the TCP/IP reference model.

In the illustrated embodiments of the automation system in accordance with the invention, the first order network devices 1, 1′, 1″ are made such that they transmit a new item of data to the database system 2 via the first order network 3 as free of delay as possible.

In another embodiment (not shown), at least one first order network device is made such that it first stores several new data in order to then transmit them in blocks via the first order network 3 to the database system 2; this is especially advantageous with respect to the use of frame-based protocols.

Aside from the connection between the first order network devices 1, 1′, 1″ and the database system 2, everything which was stated above with respect to the automation system as shown in FIG. 1 known from the prior art also applies to the distributed automation systems in accordance with the invention shown in FIGS. 2 & 3, especially with respect to the first order network devices 1, 1′, 1″ and their connection to the lower order network devices 6, 6′ via lower order networks 5, 5′. The data administered and filed on the database system 2 are especially status and diagnosis data of the first order network devices 1, 1′, 1″ and/or lower order network devices 6, 6′.

For the embodiments of the distributed automation system in accordance with the invention shown in FIGS. 2 & 3, the computer 8 which is used for evaluation of the data filed in the database system 2 is connected to the database system 2 via a separate data channel 7. In contrast to the evaluation and switching computer 4 shown in FIG. 1, the computer 8 is however not necessary for operation of the database system 2. The computer 8 is used especially for data evaluation, data display and/or diagnosis of the automation system. FIG. 3 shows that the computer 8 can be connected to the first order network devices 1, 1′, 1″ not only via the separate data channel 7, but also via the first order network 3.

What is claimed is:

1. Distributed automation system, comprising:
at least one first order network device and at least one piece of data available on the first order network device,
at least one database system and
at least one first order network,
wherein the first order network device and the database system are directly interconnected via the first order network, the piece of data from the first order network device being actively and directly transmittable via the first order network to the database system.

2. Distributed automation system in accordance with claim 1, wherein serial data transmission is implementable with the first order network.

3. Distributed automation system in accordance with claim 1, wherein the first order network is based on the Ethernet standard.

4. Distributed automation system in accordance with claim 3, wherein communication between the first order network device and the database systems is based on the TCP/IP protocol.

5. Distributed automation system in accordance with claim 1, wherein a new item of data on the first order network device is transmittable from the first order network device to the database system via the first order network as free of delay as possible.

6. Distributed automation system in accordance with claim 1, wherein new data is stored on the first order network device and is transmittable in block form from the first order network device via the first order network to the database system.

7. Distributed automation system in accordance with claim 1, wherein the first order network device is connected via at least one lower order network to at least one lower order network device.

8. Distributed automation system in accordance with claim 7, wherein the lower order network is a field bus and the lower order network device is a field device.

9. Distributed automation system in accordance with claim 1, wherein the data in the first order network device are at least one of external data and data generated in the first order network device

10. Distributed automation system in accordance with claim 9, wherein the data in the first order network device comprise status and diagnosis data of at least one of the first order network devices and lower order network devices.

11. Distributed automation system in accordance with claim 1, wherein the at least one database system is connected to a computer via at least one of the first order network and a separate data channel, data stored in the database system being transmittable to the computer, for data evaluation, data display and diagnosis of the automation system.

12. Process for data acquisition in a distributed automation system, with at least one network device, at least one piece of data available on the network device, at least one database system for administration of the data originating from the network device, and at least one network, comprising the steps of:
connecting the network device and the database directly to one another via the network, and
actively transmitting data from the at least one network device via the at least one network to the at least one database system.

13. Process in accordance with claim 12, wherein new data are stored on the first order network device and are transmitted in block form from the first order network device via the first order network to the database system.

14. Process in accordance with claim 12, with a computer connected via a separate data channel to the database system, wherein the data stored in the at least one database system are at least one of transmitted from the at least one database system to the computer and retrieved by the computer from the database system.
